(19) United States
(12) Patent Application Publication
(10) Pub. No.: US 2026/0029647 A1
(43) Pub. Date: Jan. 29, 2026

(54) OPTICAL MODULE AND HEAD-MOUNTED DISPLAY DEVICE

(71) Applicant: GOERTEK OPTICAL TECHNOLOGY CO., LTD., Shangdong (CN)

(72) Inventor: YUDENG WU, Shangdong (CN)

(73) Assignee: GOERTEK OPTICAL TECHNOLOGY CO., LTD., Shangdong (CN)

(21) Appl. No.: 18/996,123

(22) PCT Filed: Jul. 26, 2022
(86) PCT No.: PCT/CN2022/108011

§ 371 Date: Jan. 17, 2025

(51) Int. Cl. G02B 27/01; G02B 27/09; G02B 27/14; G02B 27/28

(52) U.S. Cl. CPC G02B 27/0172; G02B 27/0955; G02B 27/145; G02B 27/283

(57) ABSTRACT

The disclosure provides an optical module and a head mounted display. The optical module includes: a display screen with a size of D1; a lens group located on a light-emitting side of the display screen; the lens group includes at least one lens; the optical module further includes a polarizing element, a beam splitting element and a phase retarder, wherein the polarizing element and the beam splitting element are provided with the at least one lens of the lens group therebetween, and the phase retarder is located on the light-emitting side of the display screen; wherein a distance from the beam splitting element to the display screen is A3, which satisfies:

$$1 < ( D 1 / 2 ) / A 3 < 9.$$

### CROSS-REFERENCE TO RELATED APPLICATIONS

The present disclosure is a National Stage of International Application No. PCT/CN2022/108011, filed on Jul. 26, 2022, which is hereby incorporated by reference in its entirety.

### TECHNICAL FIELD

Embodiments of the present disclosure relate to the technical field of near-eye display imaging, and particularly to an optical module and a head mounted display.

### BACKGROUND

In recent years, Augmented Reality (AR) and Virtual Reality (VR) technologies have found applications in devices such as a smart wearable device and have rapidly developed. Both AR and VR technologies rely on optical modules as their core components. The quality of image display produced by the optical modules directly determines the quality of a smart wearable device.

With the diversification of people's needs, there is a growing trend towards miniaturing VR display devices in order to reduce their weight and spatial footprint. However, this downsizing and lightweighting can inadvertently compromise the image clarity and immersive experiences that these devices provide to users. Therefore, a pressing technical challenge to be solved is how to provide a compact VR display device without sacrificing the imaging quality.

### SUMMARY

An objective of the present disclosure is to provide new technical solutions for an optical module and a head mounted display.

According to a first aspect, the present disclosure provides an optical module, which includes:
a display screen with a size of D1; and
a lens group located on a light-emitting side of the display screen; the lens group includes at least one lens;
wherein the optical module further includes a polarizing element, a beam splitting element and a phase retarder, wherein the polarizing element and the beam splitting element are provided with at least one lens therebetween, and the phase retarder is located on the light-emitting side of the display screen;
wherein a distance from the beam splitting element to the display screen is A3;
wherein the optical module satisfies: 1<(D1/2)/A<9.

Optionally, the optical module satisfies: an incident angle of a marginal field of view ranges from −38° to 30°.

Optionally, the beam splitting element has an effective diameter B2 ranging from 33 mm to 51 mm.

Optionally, the optical module has a total optical length ranging from 10 mm to 25 mm.

Optionally, the lens group includes a first lens close to an eye side, the first lens includes a surface facing away from the eye side, and the polarizing element is provided on a side of the surface.

Optionally, the lens group includes a lens adjacent to the display screen, the lens includes a surface facing towards the display screen, and the beam splitting element is provided on a side of the surface; or
the lens group includes at least two lenses, and the beam splitting element are provided between two adjacent lenses.

Optionally, the phase retarder includes a first phase retarder;
the lens group includes a first lens close to an eye side, the first lens includes a surface facing away from the eye side, and the first phase retarder is provided on a side of the surface and is farther away from the first lens than the polarizing element.

Optionally, the phase retarder includes a second phase retarder; the lens group includes a lens adjacent to the display screen;
the second phase retarder is provided between the lens and the display screen.

Optionally, the polarizing element and the beam splitting element are provided with one lens therebetween, and the lens is a lens either adjacent to the display screen or located between two adjacent lenses.

Optionally, the polarizing element has an effective diameter B1;
a distance from the polarizing element to the display screen is L1;
wherein the optical module satisfies: 0<(B1/2−D1/2)/L1<0.8.

Optionally, the effective diameter B1 of the polarizing element ranges from 40 mm to 50 mm;
the distance L1 from the polarizing element to the display screen ranges from 10 mm to 22 mm.

Optionally, the beam splitting element is provided on a lens of the lens group, and the lens where the beam splitting element is provided has a central thickness ranging from 4 mm to 6.5 mm.

In a second aspect, a head mounted display is proposed. The head mounted display includes:
a housing; and
the optical module according to the first aspect.

According to the embodiment of the present disclosure, by controlling the ratio of half the size of the display screen to the distance from the beam splitting element to the display screen, the optical module achieves improved compactness and a reduced overall volume.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 shows a first structural schematic diagram of an optical module provided in an embodiment of the present disclosure.

FIG. 2 shows a second structural schematic diagram of the optical module provided in an embodiment of the present disclosure.

FIG. 3 shows a third structural schematic diagram of the optical module provided in an embodiment of the present disclosure.

FIG. 4 shows a fourth structural schematic diagram of the optical module provided in an embodiment of the present disclosure.

### DESCRIPTION OF REFERENCE SIGNS

1. display screen; 2. lens group; 21. first lens; 22. second lens; 23. third lens; 3. polarizing element; 4. stop; 5. beam splitting element; 6. first phase retarder.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

In the prior art, the compactness of optical modules has been improved simply by reducing the spacing of adjacent lenses, such as by gluing lenses together. However, current approaches to enhancing compactness of optical modules do not consider the compatibility of the adjusted lens group with the display screen. For example, at present, adjustments made solely in order to solve the problem of compactness tends to limit the optical module to being compatible with only one specific screen size, thereby restricting its applicability.

Based on the above technical problems, the first aspect of the embodiments of the present disclosure provides an optical module featuring a folded light path optical structure design. This design can include at least one optical lens and is applicable in the head mounted display (HMD), such as VR headsets, including products like VR glasses or VR helmets, without any specific limitation in the embodiments of the present disclosure.

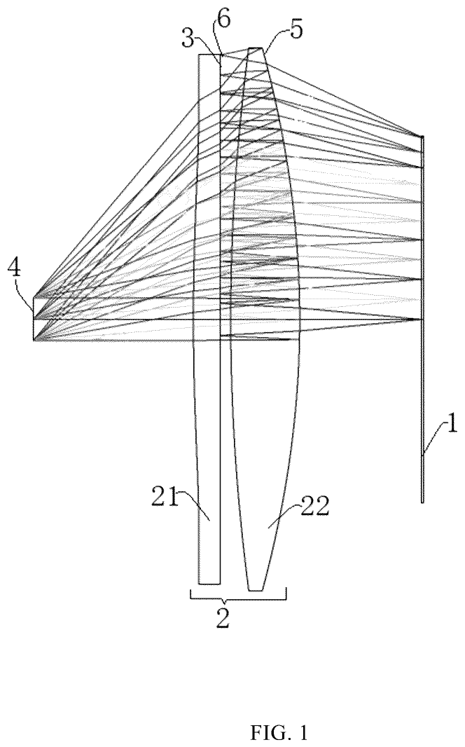

The optical module and the head mounted display provided by the embodiments of the present disclosure are described in detail below with reference to FIGS. 1 to 4.

The embodiments of the present disclosure provide an optical module. As shown in FIGS. 1 to 4, the optical module includes: a display screen 1 with a size of D1.

A lens group 2 located on a light-emitting side of the display screen 1; the lens group 2 comprises at least one lens; the optical module further comprises a polarizing element 3, a beam splitting element 5 and a phase retarder, wherein the polarizing element 3 and the beam splitting element 5 are provided with at least one lens therebetween, and the phase retarder is located on the light-emitting side of the display screen 1;
wherein a distance from the beam splitting element 5 to the display screen 1 is A3;
wherein the optical module satisfies: 1<D1/2/A<9.

In other words, the optical module mainly includes the display screen 1, the lens group 2, the polarizing element 3, the beam splitting element 5, and the phase retarder.

Here, the display screen 1 may be an LCD (Liquid Crystal Display) or an LED (Light Emitting Diode), OLED (Organic Light-Emitting Diode), Micro-OLED (Micro-Organic Light-Emitting Diode), ULED (Ultra Light Emitting Diode), Or a DMD (Digital Micro mirror Device), etc.

Here, in the present embodiment, the size of the display screen 1 is defined as D1, which refers to the maximum size for displaying an image. For example, the display screen 1 has an area for displaying the image, and the maximum size of the area defines the size of display screen 1.

Here, the lens group 2 is provided in the light-emitting direction of the display screen 1; functioning to magnify and resolve the light. In display devices such as VR (Virtual Reality), for example, to ensure that the user receives an enlarged display image, the light needs to be magnified, thereby ensuring that the user receives through the lens group 2 a recognizable enlarged image. In the folded light path, considering that light has already been folded, the number of lenses in the optical architecture of the folded light path can be up to three, compared with a direct optical architecture.

Here, in the present embodiment, to achieve the folded light paths, the optical module further includes the polarizing element 3, the beam splitting element 5, and the phase retarder. Here, at least one lens is provided between the polarizing element 3 and the beam splitting element 5, and the polarizing element 3 and the beam splitting element 5 define the length of the folded light in the folded light path.

In the present embodiment, for example, when the light passes through the beam splitting element 5, one part of the light is transmitted and the other part is reflected, without considering absorption of the light. The beam splitting element 5 may be a transflective film or a polarizing film. Regardless of where the beam splitting element 5 is provided, the distance from the beam splitting element 5 to the display screen 1 is defined as A3.

Here, the polarizing element 3 can be used to transmit P-polarized light and reflect S-polarized light; or the polarizing reflection element can be used to transmit S-polarized light and reflect P-polarized light. Specifically, the polarizing element 3 has a polarization transmission direction, and light can pass through the polarizing element 3 smoothly only when it vibrates along the polarization transmission direction, while light vibrating in other directions is reflected when it encounters the polarizing element 3. For example, the polarizing element 3 can be a polarizing reflection film, a reflective polarizer or the like.

In the present embodiment, the phase retarder may be used to change the polarization state of light in the folded light path structure, such as converting linearly polarized light into circularly polarized light or vice versa. For example, the phase retarder can be a quarter-wave plate.

In the present embodiment, the specific position of the beam splitting element 5 is not defined. For example, the beam splitting element 5 may be located on the light-emitting side of the display screen 1, that is, between the display screen 1 and a lens adjacent to it, or when the lens group 2 includes at least two lenses, the beam splitting element 5 may be located between two lenses, or may be provided on the surface of a certain lens, as long as it can achieve the transmission or reflection of light such that the optical module realizes an folded optical path.

In the present embodiment, the lens group 2 includes the beam splitting element 5, and regardless of the specific position where the beam splitting element 5 is placed, the present embodiment defines the distance from the beam splitting element 5 to the display screen 1 to be A3.

In the present embodiment, it is limited that (D1/2)/A3 falls within this range, that is, 2<D1/(2A3)<18, so that the optical module meets the requirement on better system compactness.

Specifically, considering that the closer the distance from the beam splitting element 5 to the display screen 1, the longer the path of the incident light emitted by the display screen 1 becomes when it returns within the lens group 2, resulting in a shorter size of the display screen 1. When the optical module has a short focal length, the closer the distance from the beam splitting element 5 to the display screen 1, the smaller the size of the display screen 1, and at this point, the distance from the beam splitting element 5 to the display screen 1 and the size of the display screen 1 tend to become smaller at the same time. Conversely, when the corresponding optical module has a long focal length, the size of the display screen 1 is larger, and the distance from the beam splitting element 5 to the display screen 1 is farther, and at this point, the distance from the beam splitting element 5 to the display screen 1 and the size of the display screen 1 tend to become larger at the same time. Taking into account the interrelation between the focal length of the optical module, the size of the display screen 1, and the distance from the beam splitting element 5 to the display screen 1, constraining the ratio between half the size of the display screen 1 and the distance from the beam splitting element 5 to the display screen 1 within this range ensures a compact structure for the optical module.

Specifically, constraining (D1/2)/A3 within this range also ensures optimal compatibility between the beam splitting element 5 and the display screen 1, as well as better matching of the overall architecture of the lens group 2 with the display screen 1. Specifically, (D1/2)/A3 primarily adjusts the overall compactness of the optical module, optimizing the relationship between the distance A3 from the beam splitting element 5 to the display screen 1 and the size of the display screen 1 for the best system balance, thereby enhancing system compactness of the optical module.

In one embodiment, the optical module satisfies: 3<(D1/2)/A3<7.

In the present embodiment, the range of (D1/2)/A3 in the optical module has been further reduced. Here, the smaller the value of (D1/2)/A3—that is, the closer it is to 1—the larger the size of the display screen 1 that can be matched with the lens group 2, that is, the lens group 2 can be matched with a large-sized or medium-sized display screen 1; wherein, the larger the value of (D1/2)/A3—that is, the closer it is to 9—the smaller the size of the display screen that can be matched with the lens group 2, that is, the lens group 2 can be matched with a small-sized display screen 1.

However, it should be noted that the present embodiment does not specifically limit the selection of the size of the display screen 1 based on (D1/2)/A3, as long as the ratio between half the size of the display screen 1 and the distance from the beam splitting element 5 to the display screen 1 falls within this range, such that the optical module has the compactness, and the lens group 2 and the display screen 1 have a better match.

It should be noted that in the embodiment of the present disclosure, those skilled in the art can flexibly adjust the ratio relationship between half the size of the display screen 1 and the distance from the beam splitting element 5 to the display screen 1 in the optical module according to specific needs, as long as this ratio is controlled within a preset range.

For example, the range of (D1/2)/A3 could be 2 to 8.

Or, the range of (D1/2)/A3 could be 3 to 6.

Or again, the range of (D1/2)/A3 could be 4 to 5.

Within the above various ratio ranges, a compact optical module system can be achieved.

Of course, in the embodiment of the present disclosure, the ratio relationship between half the size of the display screen 1 and the distance from the beam splitting element 5 to the display screen 1 in the optical module is not limited to the above three examples, which may be flexibly adjusted by those skilled in the art and is not specifically limited by the embodiment of the present disclosure.

In one embodiment, the optical module satisfies: an incident angle of a marginal field of view ranges from −38° to 30°.

In the present embodiment, the display screen 1 comprises pixels arranged in rows and columns, each pixel is one light-emitting unit, and rays emitted from the light-emitting unit forms conically diverging rays. The incident light emitted by the display screen 1 includes chief rays, which correspond to the central field of view, and marginal rays located around the chief rays, which correspond to the marginal field of view.

In the present embodiment, the incident angle of the marginal field of view is defined so that in the compact architecture of the optical module, both the rays from the marginal field of view and the rays from the central field of view can enter the human eye and form image, allowing the user to observe a complete imaging scene through visual observation.

For example, the incident angle for the marginal field of view could be: −21° to 10°; or the incident angle for the marginal field of view could be: −15° to 25°; or the incident angle for the marginal field of view could be: −10° to −1°.

In one embodiment, the beam splitting element 5 has an effective diameter B2 ranging from 33 mm to 51 mm.

In a specific embodiment, the beam splitting element 5 in the optical module is not independently provided within the optical module, but is integrated into it via the surface of a lens within the lens group 2, or through an optical component located between adjacent lenses, or via an optical component located between a lens and the display screen 1. For example, the optical component may be a flat glass structure.

In the present embodiment, the effective diameter B2 of the beam splitting element 5 is defined to achieve a reasonable match with the distance A3 from the beam splitting element 5 to the display screen 1. For example, by setting the ratio of the effective diameter B2 of the beam splitting element 5 to the distance A3 from the beam splitting element 5 to the display screen 1, the B2/A3 ratio can range from 4.5 to 6, such that the compactness of the optical module and its effective diameter are matched, the optical module has a compact performance, and the overall effective diameter of the optical module should not be too large, thereby meeting the requirements for lightweight and miniaturized design.

In one embodiment, the optical module has a total optical length ranging from 10 mm to 25 mm.

In the present embodiment, the total optical length of the optical module is defined so that the compactness of the optical module architecture and the total optical length of the optical module are reasonably matched. For example, the optical module is limited to satisfy: 1<(D1/2)/A3<9, and the total optical length of the optical module is controlled between 10 mm and 25 mm, thereby improving the compactness of the optical module architecture and reducing the total optical length of the optical module. Here, the total optical length of the optical module is set to be: the distance from the surface, which faces away from the display screen 1, of the lens farthest from the display screen 1, to the display screen 1 is the total optical length of the optical module.

In one embodiment, referring to FIGS. 1 to 4, the lens group 2 comprises a first lens 21 close to an eye side, the first lens 21 comprises a surface facing away from the eye side, and the polarizing element 3 is provided on a side of the surface.

In the present embodiment, with reference to FIGS. 1 to 4, regardless of whether the lens group comprises one lens, two lenses, or three lenses, etc., the lens group 2 includes a first lens 21 close to the eye side, i.e., the lens group 2 always includes a first lens 21 provided adjacent to the human eye. The light is processed by the first lens 21, and the processed light is output to the human eye for imaging.

Here, the first lens 21 has a surface provided facing towards the human eye and a surface provided facing away from the human eye. The polarizing element 3 is provided on a side of the surface facing away from the human eye, for example, the polarizing element 3 may be provided on the surface facing away from the human eye, or the polarizing element 3 is provided between the first lens and a lens provided adjacent thereto.

It should be noted that the present embodiment does not limit the specific setting position of the polarizing element 3, as long as it is possible to realize a compact optical module while realizing the folded optical path.

In one embodiment, with reference to FIGS. 1 to 4, the lens group 2 comprises a lens adjacent to the display screen 1, the lens comprises a surface facing towards the display screen, and the beam splitting element 5 is provided on a side of the surface;

Alternatively, the lens group 2 comprises at least two lenses, and the beam splitting element 5 are provided between two adjacent lenses.

In the present embodiment, with reference to FIGS. 1 to 4, regardless of whether the lens group comprises one lens, two lenses, or three lenses, etc., the lens group 2 includes a lens close to the display screen 1, that is, the lens group always includes a lens provided adjacent to the display screen 1. The light emitted from the display screen 1 is transmitted through the lens first, then reflected back, and finally transmitted to the human eye.

Referring to FIGS. 1, 2 and 4, wherein the lens provided adjacent to the display screen 1 has a surface facing towards the display screen 1, and the beam splitting element 5 is provided on the surface, or provided between the surface and the display screen, wherein the beam splitting element 5 is not provided on the surface.

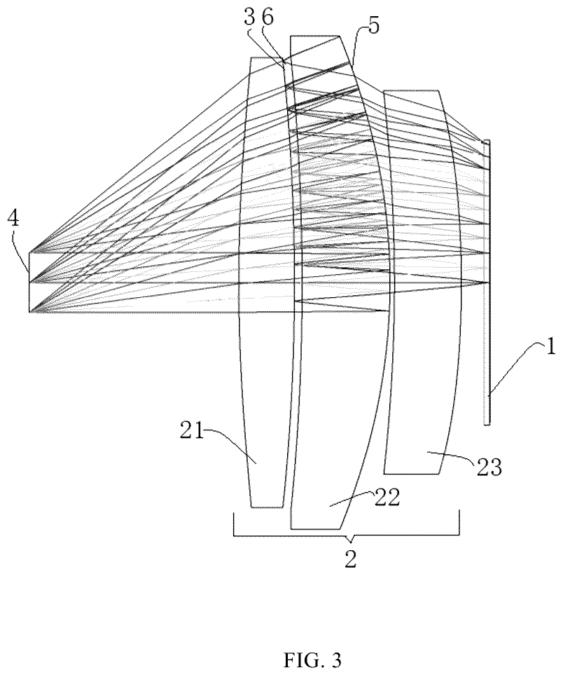

Referring to FIG. 3, the optical module includes three lenses including a first lens 21, a second lens 22, and a third lens 23 provided sequentially. The first lens 21 is provided close to the human eye, and the third lens 23 is provided close to the display screen 1.

Here, the beam splitting element 5 is provided between the second lens 22 and the third lens 23. Here, the beam splitting element 5 may be provided on the surface of the second lens 22 facing towards the third lens 23, or between the second lens 22 and the third lens 23, but is not provided on the surface of the second lens 22 facing towards the third lens 23, and may be provided between the second lens 22 and the third lens 23 by an additional optical component.

It should be noted that the present embodiment does not limit the specific setting position of the beam splitting element 5, as long as a compact optical module can be realized while realizing the folded optical path.

In one embodiment, the phase retarder comprises a first phase retarder 6; the lens group 2 comprises a first lens 21 close to an eye side, the first lens comprises a surface facing away from the eye side, and the first phase retarder 6 is provided on a side of the surface and is farther away from the first lens 1 than the polarizing element 3.

In the present embodiment, with reference to FIGS. 1 to 4, regardless of whether the lens group comprises one lens, two lenses, or three lenses, etc., the lens group 2 includes a first lens 21 close to the eye side, i.e., the lens group 2 comprises a first lens 21 provided adjacent to the human eye. The light is processed by the first lens 21, and the processed light is output to the human eye for imaging.

Here, the first lens 21 has a surface provided facing towards the human eye and a surface provided facing away from the human eye. The polarizing element 3 is provided on a side of the surface facing away from the human eye, for example, the first phase retarder 6 may be provided on the surface facing away from the human eye, or the first phase retarder 6 is provided between the first lens and a lens provided adjacent thereto.

In the present embodiment, the first phase retarder 6 is provided farther away from the first lens 1 than the polarizing element 3. The polarization state of the light that has passed through the first phase retarder 6 is changed. Here, the light is reflected by the polarizing element 3 after passing through the first phase retarder 6 for the first time, and the reflected light passes through the first phase retarder 6 again after being processed by the beam splitting element 5. Here, the light passing through the first phase retarder 6 for the second time is transmitted through the polarizing element 3 and propagates to the human eye.

It should be noted that the present embodiment does not limit the specific setting position of the first phase retarder 6, as long as a compact optical module can be realized while realizing the folded optical path.

In one embodiment, the phase retarder comprises a second phase retarder; the lens group 2 comprises a lens adjacent to the display screen 1;
the second phase retarder is provided between the lens and the display screen 1.

In the present embodiment, regardless of whether the lens group comprises one lens, two lenses, or three lenses, etc., the lens group 2 always includes a lens close to the display screen 1, that is, the lens group includes a lens provided adjacent to the display screen 1. The light emitted from the display screen 1 is transmitted through the lens first, then reflected back, and finally transmitted to the human eye.

The lens provided adjacent to the display screen 1 includes a surface provided facing towards the display screen, and a second phase retarder is provided on the surface or between the lens and the display screen 1. Here, the second phase retarder is not provided on the surface of the lens, but by providing an optical component between the lens and the display screen 1, the second phase retarder is provided between the lens and the display screen 1 by means of the optical component.

In one embodiment, one lens is provided between the polarizing element 3 and the beam splitting element 5, the lens can either be adjacent to the display screen 1 or located between two adjacent lenses.

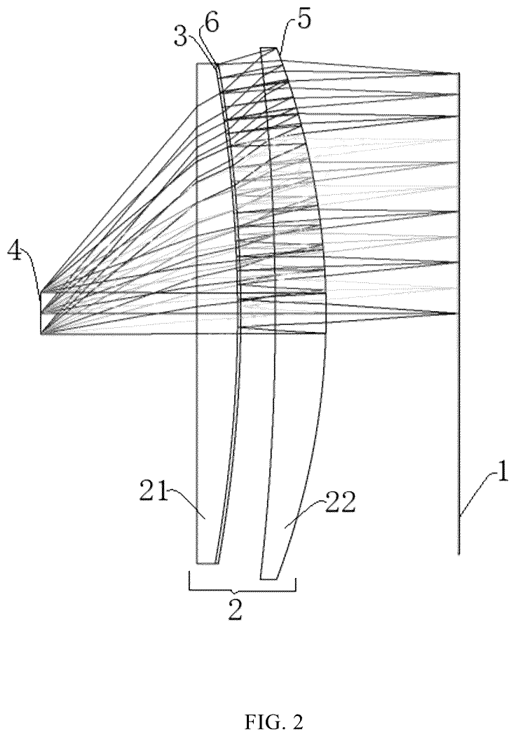

Referring to FIGS. 1 and 2, wherein the polarizing element 3 and the beam splitting element 5 are provided with one lens therebetween, and the lens is provided adjacent to the display screen 1. Here, the beam splitting element 5 is provided on the surface of the lens facing towards the display screen 1, and the polarizing element 3 is provided on the surface of a lens adjacent to the lens.

Referring to FIG. 3, one lens is provided between the polarizing element 3 and the beam splitting element 5, with this lens located between the first lens 21 and the third lens 23. Here, the beam splitting element 5 is provided on the surface of this lens facing towards the display screen 1, while the polarizing element 3 is provided on a lens adjacent to this lens, wherein the lens adjacent to this lens is a lens close to the human eye.

In one embodiment, the size of the display screen 1 is 18 mm to 46 mm; the distance from the beam splitting element 5 to the display screen 1 is 1 mm to 13 mm.

In the present embodiment, by defining the size of the display screen 1, it is possible to enable the optical module to match with a small-sized, medium-sized, or large-sized display screen 1. For example, by adjusting the distance between the beam splitting element 5 and the display screen 1 within the optical module, it is possible to enable the optical module to match with a small-sized, medium-sized, or large-sized display screen 1.

In the present embodiment, by defining the distance from the beam splitting element 5 to the display screen 1 to ensure that it is neither too short nor too long. For example, if the distance A3 from the beam splitting element 5 to the display screen 1 is too short, the lens group 2 would not be suitable for the large-sized screen. This can lead to an excessively large diameter of the beam splitting element 5, thereby increasing the overall system diameter and undermining the requirement for system miniaturization. Conversely, for example, if the distance from the beam splitting element 5 to the display screen 1 is too long, the optical module would need to match with a larger-sized display screen 1, which would fail to address the issue of compactness of the optical module.

In the present embodiment, by defining both the size of the display screen 1 and the distance from the beam splitting element 5 to the display screen 1, the ratio of half the size of the display screen 1 to the distance from the beam splitting element 5 to the display screen 1 may be controlled to meet the requirement of 1<(D1/2)/A3<9, such that the lens group 2 and the display screen 1 have a better compatibility, and that the optical module has better system compactness.

In one embodiment, the polarizing element 3 has an effective diameter B1;
a distance from the polarizing element 3 to the display screen 1 is L1;
wherein the optical module satisfies: 0<B1/2−D1/2/L1<0.8.

In the present embodiment, by restraining (B1/2−D1/2)/L1 to be within this range, the uniformity of the brightness of the displayed image is adjusted (the smaller the difference, the higher the uniformity; conversely, the larger the difference, the lower the uniformity). This ensures that when the user observes images at different viewing angles, the difference in the brightness between images at different viewing angles is small, that is, the difference in the brightness visually perceived when the user observes the image of the center region and the image of the edge region is small, and thus the user's eyes are not easily tired when observing the screen, thereby improving the user experience.

Specifically, wherein, the polarizing element 3 is the most critical and effective film layer for reflecting light in the folded light path, the light emitted by the display screen 1 is folded between the polarizing element 3 and the beam splitting element 5, and the propagating direction of the light reflected by the polarizing element 3 in the image edge area of the display screen 1 can basically correspond to the propagating direction of the light in the marginal field of view of the light source module. Specifically, the tangent value of the angle of the edge light is approximately the ratio of the difference between the diameter B1 of the second bearing component provided with the polarizing element 3 and the size diameter D1 of the display screen 1 to the distance L1 from the polarizing element 3 to the display screen 1.

Therefore, in order to better simulate the incident angle of the light emitted by the image in the display screen 1 (because the incident angle cannot be accurately controlled), the present embodiment limits the relationship of the effective diameter B1 of the bearing component of the polarizing element 3, the distance L1 from the polarizing element 3 to the display screen 1, and the size D1 of the display screen 1, such that (B1/2−D1/2)/L1 can substantially reflect the brightness relationship between the brightness of the light in the marginal field of view and the brightness of the light in the central field of view.

Specifically, (B1/2−D1/2)/L1 is within this range, so that the polarizing element 3 and the display screen 1 have a good matching effect, and the diameter of the bearing component provided with the polarizing element 3 and the display screen 11 have a good matching effect. Specifically, (B1/2−D1/2)/L1 mainly adjusts the brightness of the marginal field of view, so that the decrease range of the brightness of the marginal field of view relative to the brightness of the central field of view is controlled within 30%, thereby meeting the sensitivity of the human eye to observe the image brightness.

Therefore, in the present embodiment, the optical module satisfies: 1<(D1/2)/A3<9, and 0<(B1/2−D1/2)/L1<0.8, such that the brightness of the imaged image visually observed by the user is homogeneous on the premise that the optical module meets the requirements for compactness.

In an optional embodiment, the optical module of the present embodiment satisfies: 0<(B1/2−D1/2)/L1<0.8, so that the incident angle of the marginal field of view of the optical module is from −38° to 30°. That is, the present embodiment limits the ratio of (B1/2−D1/2)/L1 within this range, and therefore the incident angle of the simulated marginal field of view ranges from −38° to 30°. That is, the present embodiment limits the ratio of (B1/2−D1/2)/L1 within this range, optimizes the incident angle of the imaged image, and limits the brightness of the edge area of the display screen 1 to drop no more than 30%, so that the brightness of the edge area of the imaged picture imaged in the human eye drops no more than 30%.

In one embodiment, the effective diameter B1 of the polarizing element 3 ranges from 40 mm to 50 mm;
the distance from the polarizing element 3 to the display screen 1 ranges from 10 mm to 22 mm.

In the present embodiment, by defining the effective diameter of the polarizing element 3, it, on one hand, makes the range of (B1/2−D1/2)/L1 within the range of 0 to 0.8, and reduces the difference between the light brightness of the marginal field of view and the light brightness of the central field of view; on the other hand, after the light is processed by the polarizing element 3 provided on the bearing component, the processed light can better simulate the light of the marginal field of view of the optical module, so that (B1/2−D1/2)/L1 can better reflect the transmission characteristics of light in the marginal field of view.

In the present embodiment, in the optical module, wherever the polarizing element 3 is provided in the optical module, it is necessary for the distance from the polarizing element 3 to the display screen 1 to be within this range. The present embodiment controls the distance from the polarizing element 3 to the display screen 1, which, on one hand, makes the range of (B1/2−D1/2)/L1 within the range of 0 to 0.8, and reduces the difference between the light brightness of the marginal field of view and the light brightness of the central field of view; on the other hand, by limiting the distance from the polarizing element 3 to the display screen 1, the total optical length of the optical module is limited within a certain range, such that optical module meet the requirements on miniaturization and light weight.

In one embodiment, the beam splitting element 5 is provided on the lens of the lens group 2, and the central thickness of the lens provided with the beam splitting element 5 is from 4 mm to 6.5 mm.

In the present embodiment, the central thickness of the lens provided with the beam splitting element 5 is defined so that the total optical length of the optical module is limited within a certain range, and that the compactness and the total optical length of the optical module are better matched.

According to a second aspect of an embodiment of the present disclosure, a head mounted display is provided. The head mounted display includes: a housing; and the optical module as described above.

The head mounted display is, for example, a VR headset, including VR glasses or a VR helmet, which is not specifically limited in the embodiment of the present disclosure.

The specific implementation of the head mounted display in the embodiment of the present disclosure may refer to the above embodiments of the display module, and is not repeated herein.

The optical module provided by the embodiment of the present disclosure is specifically described below through four embodiments.

### First Embodiment

Referring to FIG. 1, the optical module provided by the embodiment of the present disclosure includes a display screen 1, a first lens 21, a second lens 22, a beam splitting element 5 and a stop 4, wherein the first lens 21 has a second surface facing towards the display screen 1 and a first surface facing away from the display screen 1; the second lens 22 has a first surface provided adjacent to the first lens 21 and a second surface facing towards the display screen 1; the beam splitting element 5 is provided on the second surface of the second lens 22, and the polarizing element 3 and the first phase retarder 6 are provided on the second surface of the first lens 21. Here the setting position of the stop 4 is the position of human eyes.

Here, the dimension D1 of the display screen 1 is 34 mm, and the distance A3 from the beam splitting element 5 to the display screen 1 is 11.4 mm; wherein the effective diameter B1 of the polarizing element 3 is 49.6 mm (wherein the polarizing element 3 is provided on the first lens 21, which also means that the effective diameter B1 of the first lens 21 is 49.6 mm), the distance L1 from polarizing element 3 to display screen 1 is 18.9 mm, wherein the effective diameter B2 of the beam splitting element 5 is 50.8 mm (wherein the beam splitting element 5 is provided on the second lens 22, which also means that the effective diameter B2 of the second lens 22 is 50.8 mm), and wherein the optical length of the optical module is 21.4 mm. Here the central thickness of the lens on which the beam splitting element 5 is provided is 6.5 mm.

Here, the optical parameters of the display screen 1, the first lens 21, the second 22 and the stop 4 are shown in Table 1.

| | | Curvature | | | |
|---|---|---|---|---|---|
| | | radius | Thickness | Refractive | Diameter |
| Type | Part | (mm) | (mm) | index (Nd) | (mm) |
| stop | Stop | Infinity | 15 | | 4 |
| first lens | P1S1 | 217.6 | 2.5 | 1.534 | 49.6 |
| | P1S2 | Infinity | 1 | 1.534 | 49.6 |
| second lens | P2S1 | 189 | 6.5 | 1.5447 | 50.8 |
| | P2S2 | −89.9 | 11.4 | 1.5447 | 50.8 |
| display | Display | Infinity | | | 34 |
| screen | | | | | |

The present embodiment is adapted to the size of an image surface of FOV of 100° and 34 mm (medium-sized screen). In the present embodiment, (D1/2)/A3=1.662, such that the optical module has good compactness.

The present embodiment is adapted to the size of an image surface of FOV of 100° and 34 mm, and the incidence angle of the light in the marginal field of view is −20.1°. In the present embodiment, (B1/2−D1/2)/L1=0.333, and then the display brightness of the marginal field of view is controlled to decrease by 25% to 30% compared to the brightness at a 0° angle (central field of view). That is, the brightness of light in the marginal field of view has been reduced, thereby enhancing the uniformity of brightness of the display screen 1.

### Second Embodiment

Referring to FIG. 2, the optical module provided by the embodiment of the present disclosure includes a display screen 1, a first lens 21, a second lens 22, a beam splitting element 5 and a stop 4, wherein the first lens 21 has a second surface facing towards the display screen 1 and a first surface facing away from the display screen 1; the second lens 22 has a first surface provided adjacent to the first lens 21 and a second surface facing towards the display screen 1; the beam splitting element 5 is provided on the second surface of the second lens 22, and the polarizing element 3 and the first phase retarder 6 are provided on the second surface of the first lens 21. Here the setting position of the stop 44 is the position of the human eye.

Here, the dimension D1 of the display screen 1 is 46 mm, and the distance A3 from the beam splitting element 5 to the display screen 1 is 12.61 mm; wherein the effective diameter B1 of the polarizing element 3 is 48 mm (wherein the polarizing element 3 is provided on the first lens 21, which means that the effective diameter B1 of the first lens 21 is 48 mm), the distance L1 from the polarizing element 3 to the display screen 1 is 21.1 mm, wherein the effective diameter B2 of the beam splitting element 5 is 51 mm (wherein the beam splitting element 5 is provided on the second lens 22, which means that the effective diameter B2 of the second lens 22 is 51 mm), and wherein the optical length of the optical module is 25 mm. Here the central thickness of the lens on which the beam splitting element 5 is provided is 4.87 mm.

Here, the optical parameters of the display screen 1, the first lens 21, the second lens 22 and the stop 4 are shown in Table 2.

| | | Curvature | | | |
|---|---|---|---|---|---|
| | | radius | Thickness | Refractive | Diameter |
| Type | Part | (mm) | (mm) | index (Nd) | (mm) |
| stop | Stop | Infinity | 15 | | 4 |
| first lens | P1S1 | Infinity | 3.9 | 1.534 | 48 |
| | P1S2 | −131.64 | 3.62 | 1.534 | 48 |
| second lens | P2S1 | −228.64 | 4.87 | 1.5447 | 51 |
| | P2S2 | −69.26 | 12.61 | 1.5447 | 51 |
| display | Display | Infinity | | | 46 |
| screen | | | | | |

The present embodiment is adapted to the size of an image surface of FOV of 100° and 46 mm (large-sized screen). In the present embodiment, (D1/2)/A3=1.823, such that the optical module has good compactness.

The present embodiment is adapted to the size of an image surface of FOV of 100° and 46 mm, and the incidence angle of the light in the marginal field of view is −0.9°. In the present embodiment, (B1/2−D1/2)/L1=0.095, and then the display brightness of the marginal field of view is controlled to decrease by no more than 10% compared to the brightness at a 0° angle (central field of view). That is, the brightness of light in the marginal field of view has been reduced, thereby enhancing the uniformity of brightness of the display screen 1.

### Third Embodiment

Referring to FIG. 3, the optical module provided by the embodiment of the present disclosure includes a display screen 1, a first lens 21, a second lens 22, and a third lens 23. Here, the first lens 21 is provided farther away from the display screen 1 than the third lens 23, the third lens 23 is provided adjacent to the display screen 1, and the second lens 22 is located between the first lens 21 and the third lens 23.

The first lens 21 has a first surface facing away from the second lens 22 and a second surface provided adjacent to the second lens 22, the second lens 22 has a first surface provided adjacent to the first lens 21 and a second surface provided adjacent to the third lens 23, and the third lens 23 has a first surface provided adjacent to the second lens 22 and a second surface facing towards the display screen 1.

The polarizing element 3 and the first phase retarder 6 are provided on the second surface of the first lens 21, and the beam splitting element 5 is provided on the second surface of the second lens 22.

Here, the dimension D1 of the display screen 1 is 18.5 mm, and the distance A3 from the beam splitting element 5 to the display screen 1 is 6.263 mm; wherein the effective diameter B1 of the polarizing element 3 is 30 mm (wherein the polarizing element 3 is provided on the first lens 21, which means that the effective diameter B1 of the first lens 21 is 30 mm), the distance L1 from the polarizing element 3 to the display screen 1 is 12.645 mm, wherein the effective diameter B2 of the beam splitting element 5 is 32.9 mm (wherein the beam splitting element 5 is provided on the second lens 22, which means that the effective diameter B2 of the second lens 22 is 32.9 mm), and wherein the optical length of the optical module is 16.365 mm. Here the central thickness of the lens on which the beam splitting element 5 is provided is 5.872 mm.

Here, the optical parameters of the display screen 1, the first lens 21, the second lens 22, the third lens 23 and the stop 4 are shown in Table 3.

| | | Curvature | | | |
|---|---|---|---|---|---|
| | | radius | Thickness | Refractive | Diameter |
| Type | Part | (mm) | (mm) | index (Nd) | (mm) |
| stop | Stop | Infinity | 14 | | 4 |
| first lens | P1S1 | 115.78 | 3.72 | 1.534 | 30 |
| | P1S2 | −114.36 | 0.51 | 1.534 | 30 |
| second lens | P2S1 | −157.26 | 5.872 | 1.5447 | 32.9 |
| | P2S2 | −40.77 | 0.298 | 1.5447 | 32.9 |
| third lens | P3S1 | −106.74 | 4.468 | 1.5447 | 25.6 |
| | P3S2 | −71.34 | 1.497 | 1.5447 | |
| display | Display | Infinity | | | 18.5 |
| screen | | | | | |

The present embodiment is adapted to the size of an image surface of FOV of 100° and 18.5 mm (small-sized screen). In the present embodiment, (D1/2)/A3=1.517, such that the optical module has good compactness.

The present embodiment is adapted to the size of an image surface of FOV of 100° and 34 mm, and the incidence angle of the light in the marginal field of view is 28.85°. In the present embodiment, (B1/2−D1/2)/L1=0.455, and then the display brightness of the marginal field of view is controlled to decrease by no more than 20% compared to the brightness at a 0° angle (central field of view). That is, the brightness of light in the marginal field of view has been reduced, thereby enhancing the uniformity of brightness of the display screen 1.

### Fourth Embodiment

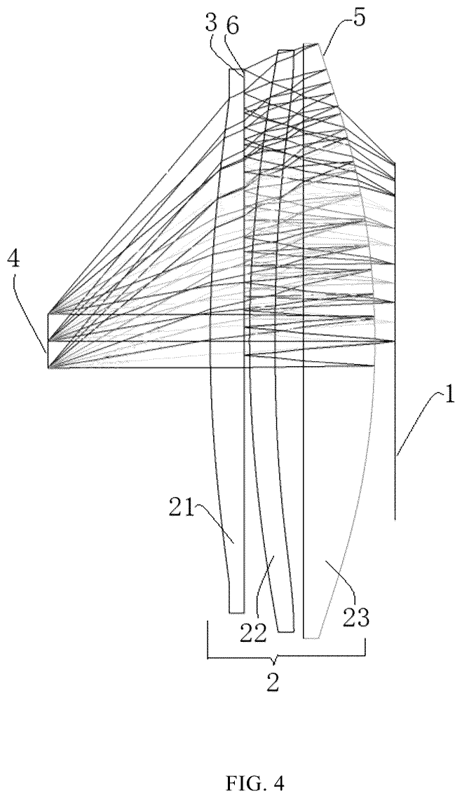

Referring to FIG. 4, the optical module provided by the present disclosure includes a display screen 1, a first lens 21, a second lens 22, and a third lens 23, wherein the first lens 21 is provided further from the display screen 1 than the third lens 23, the third lens 23 is provided adjacent to the display screen 1, and the second lens 22 is located between the first lens 21 and the third lens 23.

The first lens 21 has a first surface facing away from the second lens 22 and a second surface provided adjacent to the second lens 22, the second lens 22 has a first surface provided adjacent to the first lens 21 and a second surface provided adjacent to the third lens 23, and the third lens 23 has a first surface provided adjacent to the second lens 22 and a second surface facing towards the display screen 1.

The polarizing element 3 and the first phase retarder 6 are provided on the second surface of the first lens 21, and the beam splitting element 5 is provided on the second surface of the first lens 21.

Here, the dimension D1 of the display screen 1 is 26 mm, and the distance A3 from the beam splitting element 5 to the display screen 1 is 1.497 mm; wherein the effective diameter B1 of the polarizing element 3 is 40.26 mm (wherein the polarizing element 3 is provided on the first lens 21, which means that the effective diameter B1 of the first lens 21 is 40.26 mm), the distance L1 from the polarizing element 3 to the display screen 1 is 11.1583 mm, wherein the effective diameter B2 of the beam splitting element 5 is 44.05 mm (wherein the beam splitting element 5 is provided on the third lens 23, which means that the effective diameter B2 of the second lens 23 is 44.05 mm), and wherein the optical length of the optical module is 13.6713 mm. Here the central thickness of the lens on which the beam splitting element 5 is provided is 5.292 mm.

Here, the optical parameters of the display screen 1, the first lens 21, the second lens 22, the third lens 23 and the stop 4 are shown in Table 4.

| | | Curvature | | | |
|---|---|---|---|---|---|
| | | radius | Thickness | Refractive | Diameter |
| Type | Part | (mm) | (mm) | index (Nd) | (mm) |
| stop | Stop | Infinity | 12 | | 4 |
| first lens | P1S1 | 97.096 | 2.513 | 1.534 | 40.26 |
| | P1S2 | Infinity | 0.3975 | 1.534 | 40.26 |
| second lens | P2S1 | 100 | 1.886 | 1.5447 | 43.12 |
| | P2S2 | 180 | 2.0858 | 1.5447 | 43.12 |
| third lens | P3S1 | Infinity | 5.292 | 1.5447 | 44.05 |
| | P3S2 | −58.577 | 1.497 | 1.5447 | 44.05 |
| display | Display | Infinity | | | 26 |
| screen | | | | | |

The present embodiment is adapted to the size of an image surface of FOV of 100° and 26 mm (small-sized screen). In the present embodiment, (D1/2)/A3=8.684, such that the optical module has good compactness.

The present embodiment is adapted to the size of an image surface of FOV of 100° and 26 mm, and the incidence angle of the light in the marginal field of view is −37.1°. In the present embodiment, (B1/2−D1/2)/L1=0.64, and then the display brightness of the marginal field of view is controlled to decrease by no more than 30% compared to the brightness at a 0° angle (central field of view). That is, the brightness of light in the marginal field of view has been reduced, thereby enhancing the uniformity of brightness of the display screen 1.

According to another aspect of an embodiment of the present disclosure, there is also provided a head mounted display including a housing and the optical module as described above.

The above embodiments focus on the differences between the various embodiments, and the different optimization features between the various embodiments, as long as they do not contradict each other, may be combined to form a better embodiment, which will not be repeated herein considering the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising:
a display screen with a size of D1 and having a light emitting side thereof,
a lens group located on a light-emitting side of the display screen, wherein the lens group comprises at least one lens,
a polarizing element,
a beam splitting element, and
a phase retarder,
wherein the polarizing element and the beam splitting element are provided with the at least one lens of the lens group therebetween, the phase retarder is located on the light-emitting side of the display screen,
and a distance from the beam splitting element to the display screen is A3, which
satisfies: 1<(D1/2)/A3<9.

2. The optical module according to claim 1, wherein the optical module has an incident angle of a marginal field of view ranges from −38° to 30°.

3. The optical module according to claim 1, wherein the beam splitting element has an effective diameter B2 ranging from 33 mm to 51 mm.

4. The optical module according to claim 1, wherein the optical module has a total optical length ranging from 10 mm to 25 mm.

5. The optical module according to claim 1, wherein the lens group comprises a first lens proximate to an eye side, the first lens comprises a surface facing away from the eye side, and the polarizing element is provided on a side of the surface.

6. The optical module according to claim 1, wherein the lens group comprises a lens adjacent to the display screen, the lens comprises a surface facing towards the display screen, and the beam splitting element is provided on a side of the surface; or
the lens group comprises at least two lenses, with the beam splitting element provided therebetween.

7. The optical module according to claim 1, wherein the phase retarder comprises a first phase retarder;
the lens group comprises a first lens proximate to an eye side, the first lens comprises a surface facing away from the eye side, and the first phase retarder is provided on a side of the surface and is farther away from the first lens than the polarizing element.

8. The optical module according to claim 1, wherein the phase retarder comprises a second phase retarder; the lens group comprises a lens adjacent to the display screen;
the second phase retarder is provided between the lens and the display screen.

9. The optical module according to claim 1, wherein the polarizing element and the beam splitting element are provided with the at least one lens of the lens group therebetween, and the lens group comprises a lens either adjacent to the display screen or located between two adjacent lenses.

10. The optical module according to claim 1, wherein the polarizing element has an effective diameter B1;
a distance from the polarizing element to the display screen is L1, which satisfies: 0<(B1/2−D1/2)/L1<0.8.

11. The optical module according to claim 10, wherein B1 ranges from 40 mm to 50 mm;
L1 ranges from 10 mm to 22 mm.

12. The optical module according to claim 1, wherein the beam splitting element is provided on the at least one lens of the lens group, and the lens has a central thickness ranging from 4 mm to 6.5 mm, with the beam splitting element thereon.

13. A head mounted display, comprising:
a housing; and
an optical module according to claim 1.
